(19) United States
(12) Patent Application Publication
(10) Pub. No.: US 2016/0354995 A1
(43) Pub. Date: Dec. 8, 2016

(54) SOLAR CONTROL FILM

(71) Applicant: Saint-Gobain Performance Plastics Corporation, Solon, OH (US)

(72) Inventors: Fabien LIENHART, San Diego, CA (US); William C. O'ROURKE, La Jolla, CA (US)

(21) Appl. No.: 15/172,567

(22) Filed: Jun. 3, 2016

Related U.S. Application Data
(60) Provisional application No. 62/170,407, filed on Jun. 3, 2015.

(51) Int. Cl. B32B 15/04

(52) U.S. Cl. CPC B32B 15/04; B32B 2307/412; B32B 2307/416; B32B 2311/18; B32B 2311/22; B32B 2311/30; B32B 2311/12; B32B 2311/08; B32B 2311/04; B32B 2419/00

(57) ABSTRACT

A solar control film can include a multilayer stack including a transparent metal layer and a dark metal layer separated by an interference layer. The solar control film can have an improved solar control factor.

### CROSS-REFERENCE TO RELATED APPLICATION(S)

This application claims priority to U.S. Provisional Patent Application No. 62/170,407, filed Jun. 3, 2015, entitled “Solar Control Film,” naming inventors Fabien Lienhart and William C. O'Rourke, which is incorporated herein by reference in its entirety.

### FIELD OF THE DISCLOSURE

The present disclosure relates to solar control films and solar control laminates.

### RELATED ART

Composite films can be used as coverings applied to windows in building or vehicles to control the passage of solar radiation through transmission, reflection, and absorption. For certain composite films, visible light transmittance and reflectance must be low and the total solar energy rejection must be high. This combination of features is of great importance for particular glazing systems. As such, a need exists for composite films which have superior combined visible light transmittance, visible light reflectance, and total solar energy rejection properties at the desired levels.

### BRIEF DESCRIPTION OF THE DRAWINGS

Embodiments are illustrated by way of example and are not limited in the accompanying figures.

FIG. 1 includes an illustration of an example solar control film according to certain embodiments described herein.

FIG. 2 includes an illustration of another example solar control film according to certain embodiments described herein.

FIG. 3 includes an illustration of a solar control laminate according to certain embodiments described herein.

FIG. 4 includes a graph plotting the visible light transmittance and the solar heat gain coefficient of certain samples.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solar control arts.

It is a particular advantage of certain embodiments of the solar control film described herein to satisfy strict solar control requirements while maintaining an aesthetically pleasing appearance. In certain embodiments, the solar control film can exhibit unexpected solar control properties. For example, the solar control film can have a low visible light reflectance (“VLR”), a low visible light transmittance (“VLT”), and a low solar heat gain coefficient (“SHGC”), while maintaining a low solar control factor (“SCF”). In particular embodiments, the solar control film can have a VLR of no greater than 12%, a VLT of no greater than 40%, and an SCF at least −0.4, where the VLT, SHGC, and SCF satisfy the following formula:

VLT−1.8(SHGC)≧SCF.

It is a particular advantage of certain embodiments of the solar control film described herein to include a low-cost alternative to conventional solar control. In certain embodiments, the solar control film can comprise a multilayer stack including at least one dark metal layer, at least one transparent metal layer, and at least one interference layer. For example, the multilayer stack can have layers arranged in a metal/interference/metal configuration, such as a metal/interference/metal/interference/metal configuration. In particular embodiments, the solar control film can maintain or even improve performance while being free of precious metals, dielectrics having slow deposition rates, dyed films, or any combination thereof.

The concepts are better understood in view of the embodiments described below that illustrate and do not limit the scope of the present disclosure.

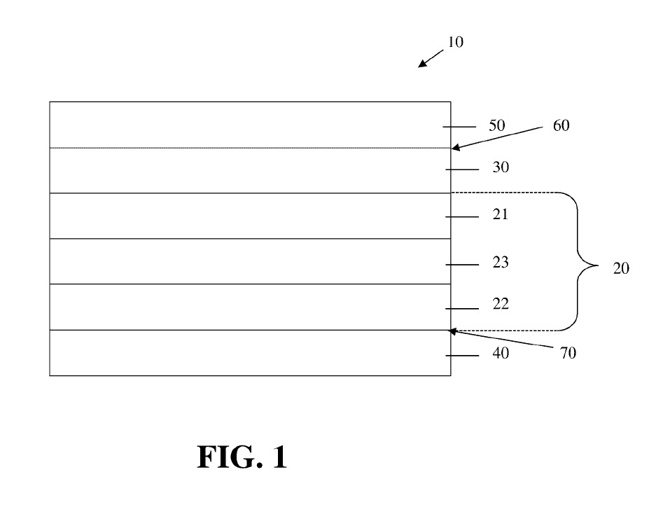

FIG. 1 includes an illustration of an example solar control film 10 comprising a multilayer stack 20 including a pair of metal layers 21, 22 separated by an interference layer 23. In certain embodiments, the metal layer 21 can include a dark metal layer and the metal layer 22 can include a transparent metal layer. In particular embodiments, as illustrated in FIG. 1, the pair of metal layers 21, 22 can form the outermost layers of the multilayer stack. Further, the multilayer stack 20 can be disposed between a substrate layer 30 and a counter layer 40. Furthermore, the solar control film can be disposed on a glass substrate 50. Moreover, the solar control film can include a pressure sensitive adhesive layer 60, a laminating adhesive layer 70, or both as illustrated in FIG. 1, disposed on one or more of the substrate layers.

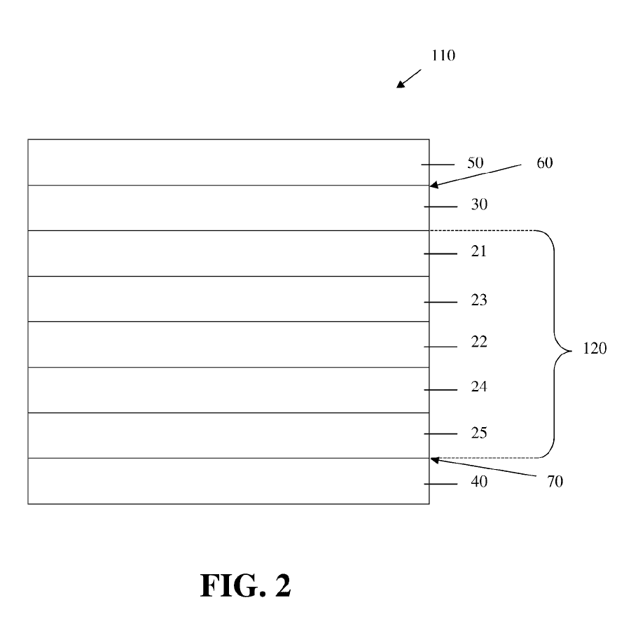

FIG. 2 includes an illustration of an example solar control film 110 comprising a multilayer stack 120 disposed between the substrate layer 30 and the counter layer 40. In certain embodiments, the multilayer stack 120 can include the pair of metal layers 21, 22 separated by the interference layer 23. In addition, the multilayer stack 120 can include an additional interference layer 24 and an additional metal layer 25. In particular embodiments, the metal layer 25 can be a second dark metal layer.

It is to be understood that the solar control films illustrated in FIGS. 1 and 2 are illustrative embodiments. All of the embodiments illustrated are not required, and any number of additional embodiments, or fewer embodiments, or different arrangement of embodiments than shown is within the scope of the present disclosure.

As stated previously, the multilayer stack of the solar control film can include a dark metal layer. The dark metal layer, as the name suggests, can include a dark metal. As used herein, the term “metal” refers to an elemental metal or a metal alloy. As used herein, the term “elemental metal” refers to a metal of a single type of atom having an oxidation state at or near 0, whereas the term “metal alloy” refers to a mixture of two or more types of metals having an oxidation state at or near 0. As used herein, the term “dark metal” refers to a material exhibiting a metallic reflective behavior as well as significant light absorption properties. That is, a dark metal has coefficient of extinction (“k”) high enough to exhibit metallic behavior and a refractive index at 550 nm (“n”) that is not so high as to correspond to a shiny metal. In certain embodiments, the dark metal can have a k/n ratio of at least 0.5, at least 0.6, or at least 0.7. In further embodiments, the dark metal can have a k/n ratio of no greater than 2, no greater than 1.9, or no greater than 1.85. Moreover, the dark metal can have a k/n ratio in a range of any of the above minimum and maximum values, such as 0.5 to 2, 0.6 to 1.9, or 0.7 to 1.85. See Table 1 for a list of example metals and their k/n ratios.

TABLE 1
Optical properties at 550 nm

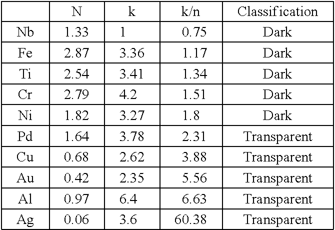

In certain embodiments, a dark metal can include a titanium, a nickel, a chromium, an iridium, an iron, or any combination thereof, such as an Inconel, a Stainless Steel, or a NiCr. Moreover, a dark metal can include any metal recognized in the art as a gray metal or having the light transmission properties of such metals.

In certain embodiments, the light transmission properties of a dark metal layer can be dependent on its thickness. Further, the sufficient thickness for a dark metal layer can be dependent on a given metal. The thickness of the dark metal layer can be described according to its geometrical thickness. As used herein, the term “geometrical thickness” refers to the actual spatial thickness of the layer from one interface of the layer to the opposite interface of the layer. In certain embodiments, the dark metal layer can have a geometrical thickness of at least 2 nm, such as at least 4 nm, or even at least 6 nm. In further embodiments, the dark metal layer can have a geometrical thickness of no greater than 24 nm, such as no greater than 22 nm, or even no greater than 20 nm. Moreover, the dark metal layer can have a geometrical thickness in a range of any of the above minimum or maximum values, such as 2 to 24 nm, 4 to 22 nm, or even 6 to 24 nm.

In certain embodiments, the dark metal layer can be a discontinuous layer. As used herein, the term “discontinuous layer” refers to a rough, non-percolated, non-fully coalesced, or dendritic layer that may include fissures, cracks, or pits. In particular embodiments, when the dark metal layer is a discontinuous layer, its surface irregularities can increase the absorption of light.

In alternative embodiments, the dark metal layer can be a continuous layer. As used herein, the term “continuous metal layer” refers to a smooth, coherent, or monolithic layer having a substantially uniform thickness, free of significant fissures, cracks, and pits. As used herein, the term “substantially uniform thickness,” in the context of layer thickness, refers to a mean thickness greater than or equal to 80 percent of the maximum thickness and lacking deformities extending greater than 25 percent of the thickness of the layer from its surface.

In certain embodiments, the multilayer stack can include a plurality of dark metal layers. For example, as illustrated in FIG. 2, the multilayer stack can include a first dark metal layer 21 and a second dark metal layer 25. In particular embodiments, the first dark metal layer can be identical to the second dark metal layer. In alternative embodiments, the first dark metal layer can be different than the second dark metal layer, such as in one or more, or all, of the following ways. In particular embodiments, the first dark metal layer can include a different type of metal than the second dark metal layer, the first dark metal layer can have a different (smaller or greater) thickness than the second dark metal layer, the first dark metal layer can have a different (higher or lower) visible light transmission than the second dark metal layer, or any combination of these differences. Additionally, the first and second dark metal layers can each separately include a continuous metal layer or a discontinuous metal layer.

As stated previously, the multilayer stack of the solar control film can include a transparent metal layer. The transparent metal layer, as the name suggests, can include a transparent metal. As used herein, the term “transparent metal” refers to a material that exhibits less absorption and more reflection than certain dark metals, for a given thickness. That is, a transparent metal has a high k/n ratio, such as at least 1.85. In certain embodiments, the transparent metal can have a k/n ratio of at least 2, at least 2.5, or even at least 3, as referred to in Table 1, above.

In certain embodiments, the transparent metal can include a gold, a copper, a silver, or any combination thereof. In particular embodiments, the transparent metal layer can include a copper. In more particular embodiments, the transparent metal layer can include a copper alloy comprising a brass, a bronze, a cupronickel, or any combination thereof. In further particular embodiments, the transparent metal layer can include a silver. In further particular embodiments, the transparent metal layer can include a silver alloy including a gold, a palladium, a copper, or any combination thereof.

In further embodiments, the transparent metal can include a cladded transparent metal. For example, the transparent metal can include a metal cladded with a gold, a titanium, a nickel chromium, an inconel, a copper, or any combination thereof. The cladding can be applied on one side or both sides of the transparent metal layer.

In certain embodiments, the light transmission properties of a transparent metal layer can be dependent on its thickness. Further, the sufficient thickness for a transparent metal layer can be dependent on a given material.

In certain embodiments, the thickness of the transparent metal layer can be described according to its geometrical thickness. In particular embodiments, the transparent metal layer can have a geometrical thickness of at least 6 nm, such as at least 10 nm, such as at least 15 nm, or even at least 20 nm. In further embodiments, the transparent metal layer can have a geometrical thickness of no greater than 60 nm, such as no greater than 55 nm, or even no greater than 50 nm. Moreover, the transparent metal layer can have a geometrical thickness in a range of any of the above minimum or maximum values, such as 10 to 60 nm, 15 to 55 nm, or even 20 to 60 nm.

In certain embodiments, the transparent metal layer can be a continuous metal layer, as defined above. In particular embodiments, the continuous metal layer can improve solar performance. For example, in certain embodiments, the transparent metal layer may need to act as a solar reflector and a discontinuous layer may not act efficiently as a solar reflector because it does not have a smooth, reflective surface.

As stated previously, the multilayer stack of the solar control film can include an interference layer. The term “interference layer” refers to a layer that causes optical interference between light waves reflecting from its two opposing interfaces. The optical interference caused by an interference layer can be referred to herein as an interference effect. In certain embodiments, the interference layer can have an interference effect providing a single absorption peak in the range of visible wavelengths of light.

In certain embodiments, the interference layer can comprise a non-absorbing material. As used herein, the term “non-absorbing material” refers to a material that has an extinction coefficient k approaching 0 throughout the visible wavelengths of light.

The interference layer can comprise a dielectric material. In certain embodiments, the dielectric material can include a polymer, an oxide, a nitride, an oxynitride, or any combination thereof. In particular embodiments, the dielectric material can include an oxide, a nitride, or an oxynitride of Mg, Y, Ti, Zr, Nb, Ta, W, Zn, Al, In, Sn, Sb, Bi, Ge, Si, or any combination thereof. In more particular embodiments, the oxide can include an indium oxide, a titanium oxide, a zinc oxide, a tin oxide, a silicon oxide or any combination thereof. In certain embodiments, the metal oxide can be in its full oxidized state. In further embodiments, the metal oxide can be in a substoichiometric state. In further particular embodiments, the nitride can include an aluminum nitride, a silicon nitride, or a combination thereof.

In certain embodiments, the interference effect of the interference layer can be influenced by the thickness of the interference layer. For example, the interference effect can blur as the thickness of the interference layer increases, which can result in in multiple absorption peaks in the range of visible wavelengths of light. Thus, to avoid this blurring, the interference layers should maintain a relatively thin profile.

The thickness of the interference layer can be described in terms of its geometrical thickness. In certain embodiments, the interference layer can have a geometrical thickness of no greater than 60 nm, such as no greater than 50 nm, or even no greater than 40 nm. Although a thin profile is desired, the interface layer can have a minimum geometrical thickness, such as at least 10 nm, at least 15 nm, or even at least 20 nm. Moreover, the interference layer can have a geometrical thickness in a range of any of the above minimum and maximum values, such as in a range of 10 to 60 nm, 15 to 50 nm, or 20 to 40 nm.

The thickness of the interference layer can be described in terms of optical thickness. As used herein, the term “optical thickness” refers to measuring the quantity of light that is scattered or absorbed by the layer by multiplying the geometrical thickness of the layer by the refractive index of the material. In certain embodiments, the interference layer can have an optical thickness of no greater than 120 nm, such as 100 nm, or even 80 nm. In further embodiments, the interference layer can have an optical thickness of at least 20 nm, such as at least 30 nm, or even at least 40 nm. Moreover, the interference layer can have an optical thickness in a range of any of the above minimum or maximum values, such as 20 to 120 nm, 30 to 100 nm, or even 40 to 80 nm.

The thickness of the interference layer can be described relative to the thickness of one quarter of a given wavelength of light, referred to as Quarter Wave Optical Thickness (“QWOT”). Unless otherwise stated, QWOT is measured herein based on a 550 nm wavelength. In certain embodiments, the interference layer can have a QWOT of no greater than 1.1, such as no greater than 0.8, or even no greater than 0.6. In further embodiments, the interference layer can have a QWOT of at least 0.25, such as at least 0.3, or even at least 0.4. Moreover, the interference layer can have a QWOT in a range of any of the above minimum or maximum values, such as 0.25 to 1.1, 0.3 to 0.6, or 0.4 to 0.6.

The solar control film can include a multilayer stack comprising one or more interference layers, depending on the desired application. For example, as illustrated in FIG. 1, the multilayer stack 20 can include only a first interference layer 23, whereas, as illustrated in FIG. 2, the multilayer stack can include the first interference layer 23 and a second interference layer 24. In certain embodiments the first and second interference layers 23, 24 can have the same composition, e.g. comprise the same type of material. In alternative embodiments, the first and second interference layers 23, 24 can have different compositions, e.g. comprise different types of materials, so far as they fall within the guidelines discussed above. Additionally, the first and second interference layers 23, 24 can have the same thickness (including geometrical thickness, optical thickness, or QWOT). Alternatively, the first and second interference layers 23, 24 can have different thicknesses (including geometrical thickness, optical thickness, or QWOT). In particular embodiments, when there is more than one interference layer in the multilayer stack, the total geometrical thickness of all the interference layers in a single multilayer stack is no greater than 250 nm, no greater than 230 nm, or even no greater than 200 nm.

As stated previously, the solar control film can have layers arranged in a metal/interference/metal configuration, as illustrated in FIGS. 1 and 2. Certain conventional solar control films incorporate a multilayer stack (often referred to as a Fabry-Perot filter) having layers arranged in a dielectric/metal/dielectric configuration. However, this conventional configuration generally provides a high transmission of visible light. Additionally, controlling certain solar control properties, such as VLT, of such conventional layer configurations may require adding one or more layers on top of the Fabry-Perot filter stack that would alter other solar control properties, such as increasing VLR. It is an advantage of certain embodiments of the solar control film described herein that the multilayer stack can achieve a desirable combination of solar control properties, such as VLT, VLR, and SHGC as described above, without requiring additional layers. In particular embodiments, the multilayer stack is free of layers outside of the metal/interference/metal configuration of FIG. 1 or the metal/interference/metal/interference/metal configuration of FIG. 2.

In certain embodiments, the interference layer, or each of the interference layers, is disposed between two metal layers. In particular embodiments, none of the interference layers are in contact with a substrate layer (as described below). Without being bound by theory, it is believed that an interference layer disposed directly adjacent, or in direct contact with, the substrate may affect the solar control properties, such as VLR. In certain embodiments, the multilayer stack includes one or more dark metal layers separated from a and a transparent metal layer by the interference layer, such as an interference layer having a geometrical thickness of no greater than 100 nm.

In certain embodiments, the solar control film can include a substrate layer. In certain embodiments, the substrate layer can be flexible. Further, the substrate layer can be composed of any number of different materials. In certain embodiments, the substrate layer can include a glass or a polymer. In particular embodiments, the polymer can include a polycarbonate, a polyacrylate, a polyester, such as a polyethylene terephthalate (PET), a cellulose triacetated (TCA or TAC), a polyurethane, a fluoropolymer, or any combination thereof. In more particular embodiments, the substrate layer can comprise polyethylene terephthalate (PET). In certain embodiments, the substrate in contact with the glass can have some UV additives in it, in order to ensure longer lifetime of the complete system in regular condition of use. Such substrates with UV additives are commonly called “clear weatherable” substrates. (can take more UV without degrading)

In certain embodiments, the substrate layer can have a geometrical thickness of at least about 0.1 micrometer, at least about 1 micrometer, or even at least about 10 micrometers. In further embodiments, the substrate layer can have a geometrical thickness of no greater than about 1000 micrometers, no greater than about 500 micrometers, no greater than about 100 micrometers, or even no greater than about 50 micrometers. Moreover, the substrate layer can have a geometrical thickness in a range of any of the above minimum and maximum values, such as 0.1 micrometers to 1000 micrometers, 1 micrometer to 100 micrometers, or even 10 micrometers to 50 micrometers. In other embodiments, when using a rigid substrate, such as glass, the substrate layer can have a greater geometrical thickness, such as in a range of 1 millimeter to 50 millimeters, or even 1 millimeter to 20 millimeters.

When used as a composite film for application to a rigid surface, such as a window, the substrate layer can be adapted to be disposed adjacent a surface to be covered with the film. Moreover, an adhesive layer can be disposed adjacent the substrate layer

In certain embodiments, the solar control film can further include a counter layer disposed opposite the substrate layer. For example, the counter layer can include a substrate layer. As illustrated in FIGS. 1 and 2, the solar control film 10, 110 can include a substrate layer 40 and an opposite counter layer 50. The substrate and counter layers 40, 50 can include any of the materials and thicknesses described above for the substrate layer.

In certain embodiments, the substrate layer can be a standard substrate layer. The term “standard substrate layer” refers to a substrate on which the multilayer stack is formed or deposited. The metal layers or interference layers can be formed on the standard substrate by any known technique, such as a vacuum deposition technique, for example, by sputtering or evaporation. For example, one or more of the layers of the multilayer stack can be formed by DC magnetron, pulsed DC, dual pulsed DC, or dual AC sputtering using rotatable ceramic metal oxide targets. These targets can have enough electrical conductivity to be used as cathodes in a DC magnetron sputtering process. Further, one or more of the layers of the multilayer stack can be formed by an atomic layer deposition technique.

In further embodiments, the counter layer can be a counter substrate layer. The term “counter substrate layer” refers to a substrate layer disposed over the multilayer stack (e.g. after the multilayer stack has been deposited on the standard substrate layer) opposite the standard substrate layer. In other embodiments, the counter layer can include a mechanical energy-absorbing layer, such as a plasticized polyvinyl butyral (PVB), as discussed in more detail later in this disclosure.

Certain conventional dark window films employ substrate layers comprising a colorant (often referred to as a dyed film) that can reduce the VLT of the film or glazing system. The color in the dyed film can fade or wear, diminishing performance. In addition, dyed films can add extra cost to the making of the solar control film. However, it is a particular advantage of certain embodiments of the solar control film described herein to be able to maintain a low VLT (a solar control property described in more detail below) without employing dyed films.

In certain embodiments, the substrate layer, the counter layer, or both the substrate and counter layers, can comprise a transparent substrate layer. The term “transparent substrate layer” refers to substrate layers having a high VLT and is used to distinguish from dyed films of conventional dark window films having a low VLT. For example, the substrate layer, the counter layer, or both substrate and counter layers, can have a high VLT, such as at least 80%, at least 90%, or even 95%. Other terms that can be used to describe a substrate or counter layer having this property are “clear substrate layer” or “uncolored substrate layer,” which refers to a substrate layer free, or substantially free, of a colorant that substantially reduces the VLT of the substrate layer. In certain embodiments, the substrate layer, the counter layer, or both substrate and counter layers, can be an uncolored substrate layer.

Particular advantages of the solar control film will now be described in terms of its solar control properties and performance. The properties and performance parameters described below include visible light transmittance, solar heat gain coefficient, visible light reflectance, and the solar control factor.

The term “visible light transmittance” or “VLT” refers to the percentage of the visible spectrum (380 to 780 nanometers) that is transmitted through a composite. VLT can be measured according to standard ISO 9050 using simulated light type D65. Although ISO 9050 refers to glazings, the same procedure can be used with a film taped or otherwise adhered to a glass window. A particular advantage of the present disclosure is the ability to obtain the visual light transmittance values described herein and illustrated in the Examples below, especially in combination with the other parameters described herein.

In certain embodiments, the solar control film is a low VLT solar control film. The term “low VLT” refers to a VLT of no greater than 50%. In particular embodiments, the solar control film can have a VLT of no greater than 40%, no greater than 30%, no greater than 20%, or no greater than 15%. In very particular embodiments the solar control film can have a VLT of no greater than 12% or even no greater than 10%. Although the solar control film can include a low VLT solar control film, certain embodiments of the low VLT solar control film may transmit some light in the visible wavelengths. For example, the low VLT solar control film can have a VLT of at least 3%, such as at least 5%, or even at least 7%. Moreover, the low VLT solar control film can have a VLT in a range of any of the above minimum or maximum values, such as 3 to 50%, 5 to 40%, or even 7 to 30%. In particular embodiments, the low VLT solar control film can have a VLT in a range of 3 to 15%, 3 to 12%, or even 3 to 10%.

The term “total solar energy rejection” or “TSER” refers to a measurement of the total energy rejected by a film which is the sum of the solar direct reflectance and the secondary heat transfer rejection factor towards the outside, the latter resulting from heat transfer by convection and longwave IR-radiation of that part of the incident solar radiation which has been absorbed by the film. The term “solar heat gain coefficient” or “SHGC” refers to the total flux of heat which goes through a glazing, which encompasses the solar transmission and the heat radiated inwards after heating of the glazing through absorption of the solar flux. The SHGC is the inverse of TSER, and can be calculated as SHGC=1−TSER. Both SHGC and TSER can be measured according to standard ISO 9050 using a simulated light type D65. A particular advantage of the present disclosure is the ability to maintain a low SHGC, meaning a high TSER, as described herein and illustrated in the Examples below, especially in combination with the other parameters described herein.

In certain embodiments, the SHGC of the solar control film can be no greater than 50%, no greater than 40%, no greater than 35%, or even no greater than 30%. Although in certain embodiments it may be preferable to have an SHGC of 0%, the solar control film may have an SHGC of at least 1%, at least 5%, or at least 10%. Moreover, the SHGC of the solar control film can be in a range of 0 to 50%, 1 to 40%, 5 to 35%, or 10 to 30%.

The term “visible light reflectance” or “VLR” refers to a measurement of the total visible light reflected by a glazing system. The visual light reflectance can be measured according to ISO 9050 using a simulated light type D65. A particular advantage of the present disclosure is the ability to obtain low VLR values described herein and illustrated in the Examples below, especially in combination with the other parameters described herein.

In certain embodiments, the solar control film can have a VLR of no greater than 30%, no greater than 20%, no greater than 15%, or no greater than 12%, no greater than 10%, or even no greater than 8%. Although in certain embodiments it may be preferable to have a VLR of 0%, the solar control film may reflect some visible light. For example, the solar control film can have a VLR of at least 1%, at least 2%, or at least 3%. Moreover, the solar control film can have a VLR in a range of any of the above minimum and maximum values, such as 0 to 30%, 1 to 20%, 2 to 15%. In particular embodiments, the solar control film can have a VLR in a range of 3 to 12%, 3 to 10%, or even 3 to 8%.

In certain embodiments, disposing the solar control film adjacent a glazing system can provide a film side, where the solar control film is exposed, and a glass side, where the solar control film interfaces with the glazing system. VLR can be measured from the film side (VLR_{F}) and from the glass side (VLR_{G}). In certain such embodiments, the solar control film can have a VLR_{F} of no greater than 14%, no greater than 12%, or no greater than 10%. In further embodiments, the solar control film can have a VLR_{F} of at least 1%, at least 2% or at least 3%. Moreover, the solar control film can have a VLR_{F} in a range of any of the above minimum and maximum values, such as 1 to 14%, 2 to 12%, 3 to 10%. Further, in certain such embodiments, the solar control film can have a VLR_{G} of any of the values described above for VLR_{F}. In particular embodiments, the solar control film can have a VLR_{G} that is the same as, greater than, or less than the VLR_{F}. In very particular embodiments, the solar control film can have a VLR_{G} that is less than the VLR_{F}, such as at least 5% less, at least 10% less, or even 15% less.

The term “selectivity” refers to the ratio of the light transmission of the system to the sum of the direct energy transmission of the system and the energy absorbed by the system and retransmitted into the interior of the building. The selectivity of a system can be measured according to standard ISO 9050 using simulated light type D65. Although ISO 9050 refers to glazings, the same procedure can be used with a film taped or otherwise adhered to a glass window.

In certain such embodiments, the solar control film can have a selectivity of at least 35%, at least 40% or at least 45%. In further embodiments, the solar control film can have a selectivity of no greater than 80%, no greater than 70%, or no greater than 60%. Moreover, the solar control film can have a selectivity in a range of any of the above minimum and maximum values, such as 35 to 80%, 40 to 70%, or even 45 to 60%.

As stated previously, certain embodiments of the solar control film described herein can satisfy strict solar control requirements while maintaining an aesthetically pleasing appearance. For example, the solar control film can have a superior combination of solar control properties represented by the SCF. The SCF expresses the combination of a sufficiently low VLT and SHGC, while maintaining a VLR. For example, in certain embodiments, the solar control film can have a SCF of at least −0.4 at a VLR of no greater than 12% where the VLT and SHGC satisfy the following formula:

VLT-1.8(SHGC)≧SCF.

In particular embodiments, the solar control film can have a SCF of at least −0.38 or even at least −0.36. In further embodiments, these values for SCF can be in combination with a VLR of no greater than 12%, no greater than 10%, or even no greater than 8%. In yet further embodiments, the values for SCF can be in combination with a VLT of no greater than 40%, no greater than 30%, no greater than 20%, or even no greater than 15%. The solar control properties of certain embodiments of the solar control film are unmatched by conventional solar control films.

In certain embodiments, only the multilayer stack contributes to the solar control functionality. In other words, the substrate and counter layers, such as the glass substrate layer, the standard substrate layer, the counter substrate layer, or the mechanical energy-absorbing layer, do not contribute to the superior solar control properties described above. Put differently, the differential filtering of the visible light with regard to the total flux of energy can be achieved by the multilayer, and, in certain embodiments, no additional layer such as a dyed film, a metallized coating or a wet coating with a marked spectral signature is added to the design of the substrate layer or the counter layer. For example, the substrate layers do not include any additives that contribute to these solar control properties. As discussed above, the solar control film can maintain a low VLT and, in particular embodiments, only the multilayer stack contributes to a reduction in VLT. Also, the solar control film can maintain a low VLR and, in particular embodiments, only the multilayer stack contributes to a reduction in VLR.

Emissivity is understood to refer to a value given to materials based on the ratio of heat emitted compared to a blackbody, on a scale from zero to one. Reflectivity is inversely related to emissivity. For example, a blackbody would have an emissivity of 1 and a perfect reflector would have a value of 0. A low emissivity material can have an emissivity of less than 0.5 and a high emissivity material can have an emissivity of 0.5 or greater. In certain embodiments, the solar control film can be a high emissivity film. In particular embodiments, the solar control film can have an emissivity of at least 0.55, at least 0.6, or even at least 0.7.

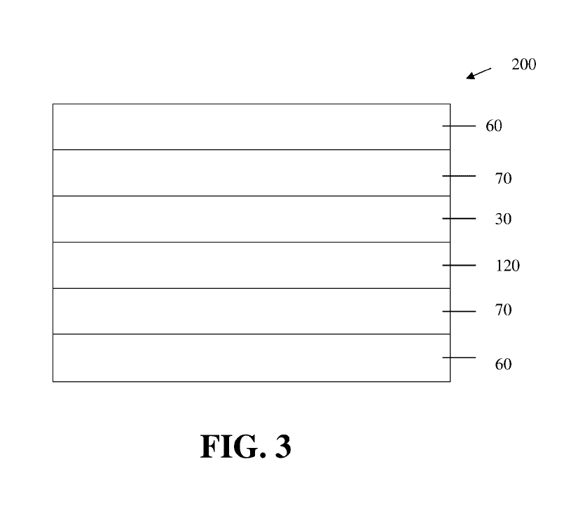

Also described herein is a solar control laminate. FIG. 3 includes an illustration of an example solar control laminate 200 in accordance with certain embodiments of this disclosure. As illustrated in FIG. 3, the solar control laminate 200 can include the multilayer stack 120 and substrate 30 illustrated in FIG. 1 and laminated between glass layers 60. Further, as illustrated in FIG. 3, a mechanical energy-absorbing layer 70 can be disposed between the each of the glass layers 60 and the solar control film 110. In certain embodiments, the mechanical energy-absorbing layer can include a plasticized polyvinyl butyral (PVB).

It is to be understood that the solar control films illustrated in FIG. 3 is an illustrative embodiment. All of the embodiments illustrated are not required, and any number of additional embodiments, or fewer embodiments, or different arrangement of embodiments than shown is within the scope of the present disclosure.

In certain embodiments, the solar control film can be prepared according to the following method. The method can include providing a standard substrate layer and depositing a multilayer stack on the standard substrate. In particular embodiments, the multilayer stack is deposited on one side of the standard substrate layer using a magnetron sputter coater. The metal layers can be deposited using the appropriate metal targets and Ar gas in the chamber at a base pressure below about 5e-5 mbar. The interference layers can be deposited using the appropriate interference material target and a mixture of Ar and O₂ gas in the chamber at a pressure of about 2.5e-3 mbar.

In certain embodiments, the substrate/multilayer system can be laminated between glass layers. In particular embodiments, the substrate/multilayer system does not require a counter substrate layer. Instead, a mechanical energy-absorbing layer can be disposed between each of the glass layers and the substrate/multilayer system.

Alternatively, in certain embodiments, the substrate/multilayer system can be laminated to a counter substrate layer using a basic laminating adhesive to form a substrate/multilayer/substrate system. The substrate/multilayer/substrate system can be laminated on a glass substrate layer by first wetting the surface of the glass, applying the pressure adhesive surface against the wet glass, and squeegeeing the excess of water while taking extra care to remove any bubbles.

It is a particular advantage of certain embodiments described herein to improve the control of incident solar energy without adding dyes or other solar control additives to the substrate. Further, in particular embodiments, the improved solar control properties can be achieved without the use of precious metals, such as silver or gold. Thus, the solar control film described herein is a low-cost alternative to existing solar control films while maintaining or even improving the solar control properties. In certain embodiments, without being limited to theory, the advantageous solar control properties of embodiments described herein can be achieved by the particular layer configuration described herein, including at least one dark metal layer separated from a transparent metal layer by an interference layer.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1. A solar control film comprising:

a substrate layer;

a multilayer stack disposed between the substrate layer and the counter layer,

wherein the solar control film has a visible light reflectance (VLR) of no greater than 12%, visible light transmittance (VLT) of no greater than 40%, and a solar control factor (SCF) of −0.38, and

wherein the VLT and a solar heat gain coefficient (SHGC) of the solar control film satisfy the following formula:

VLT-1.8(SHGC)≧SCF.

Embodiment 2. The solar control film of embodiment 1, wherein the multilayer stack includes:
a dark metal layer;
a transparent metal layer; and
a first interference layer disposed between the first dark metal layer and the transparent metal layer.

Embodiment 3. The solar control film of embodiment 2, wherein either:
a) the first dark metal layer and the transparent metal layer are the outermost layers of the of the multilayer stack, or
b) the multilayer stack further comprises a second dark metal layer and a second interference layer disposed between the transparent metal layer and the second dark metal layer.

Embodiment 4. A solar control film comprising:
a multilayer stack including:
a first dark metal layer;
a second dark metal layer;
a transparent metal layer;
a first interference layer disposed between the first dark metal layer and the transparent metal layer; and
a second interference layer disposed between the transparent metal layer and the second dark metal layer.

Embodiment 5. The solar control film of any one of the preceding embodiments, wherein the multilayer stack includes a first dark metal layer, a second dark metal layer, or both, having a k/n ratio of at least 0.5, at least 0.6, or at least 0.7.

Embodiment 6. The solar control film of any one of the preceding embodiments, wherein the multilayer stack includes a first dark metal layer, a second dark metal layer, or both, having a k/n ratio of no greater than 2, no greater than 1.9, or no greater than 1.85.

Embodiment 7. The solar control film of any one of the preceding embodiments, wherein the multilayer stack includes a first dark metal layer, a second dark metal layer, or both, including a metal or alloy including a titanium, a nickel, a chromium, an iridium, an iron, an inconel, a stainless steel, an NiCr, or any combination.

Embodiment 8. The solar control film of any one of the preceding embodiments, wherein the multilayer stack includes a first dark metal layer, a second dark metal layer, or both, having a geometrical thickness of at least 2 nm, such as at least 4 nm, or at least 6 nm.

Embodiment 9. The solar control film of any one of the preceding embodiments, wherein the multilayer stack includes a first dark metal layer, a second dark metal layer, or both, having a geometrical thickness of no greater than 24 nm, such as no greater than 22 nm, or no greater than 20 nm.

Embodiment 10. The solar control film of any one of the preceding embodiments, wherein the multilayer stack includes a first dark metal layer, a second dark metal layer, or both, have a geometrical thickness in a range of 2 to 24 nm, 4 to 22 nm, or even 6 to 24 nm.

Embodiment 11. The solar control film of any one of the preceding embodiments, wherein the multilayer stack includes a first dark metal layer, a second dark metal layer, or both, comprising a continuous layer.

Embodiment 12. The solar control film of any one of the preceding embodiments, wherein the multilayer stack includes a first dark metal layer, a second dark metal layer, or both, comprising a discontinuous layer.

Embodiment 13. The solar control film of any one of the preceding embodiments, wherein the multilayer stack includes a first dark metal layer and a second dark metal layer that are identical to each other.

Embodiment 14. The solar control film of any one of embodiments 1-12, wherein the multilayer stack includes a first dark metal layer and a second dark metal layer that includes a different type of metal than the first dark metal layer.

Embodiment 15. The solar control film of any one of embodiments 1-12 or 14, wherein the multilayer stack includes a first dark metal layer and a second dark metal layer that has a different thickness than the first dark metal layer.

Embodiment 16. The solar control film of any one of embodiments 1-12, 14, or 15, wherein the multilayer stack includes a first dark metal layer and a second dark metal layer that has a different k/n ratio than the first dark metal layer.

Embodiment 17. The solar control film of any one of embodiments 1-12 or 14-16, wherein the multilayer stack includes a first dark metal layer and a second dark metal layer, and one of the first and second metal layers is continuous and one of the first and second metal layers is discontinuous.

Embodiment 18. The solar control film of any one of the preceding embodiments, wherein the transparent metal layer has a lower thickness than the first or second, or both, dark metal layer(s).

Embodiment 19. The solar control film of any one of the preceding embodiments, wherein the transparent metal layer has a k/n ratio of at least 1.85, at least 2, at least 2.5, or at least 3.

Embodiment 20. The solar control film of any one of the preceding embodiments, wherein the transparent metal layer is continuous.

Embodiment 21. The solar control film of any one of the preceding embodiments, wherein the transparent metal layer includes a transparent metal comprising a gold, a copper, a silver, or any combination thereof.

Embodiment 22. The solar control film of embodiment 21, wherein the transparent metal layer includes a silver alloy including a gold, a palladium, a copper, or any combination thereof.

Embodiment 23. The solar control film of embodiment 22, wherein the silver alloy includes a palladium and a copper.

Embodiment 24. The solar control film of embodiment 21, wherein the transparent metal layer includes a copper alloy comprising a brass, a bronze, a cupronickel, or any combination thereof.

Embodiment 25. The solar control film of any one of the preceding embodiments, wherein the transparent metal layer includes a cladded transparent metal.

Embodiment 26. The solar control film of embodiment 25, wherein the transparent metal is a silver or a copper.

Embodiment 27. The solar control film of any one of embodiments 25 or 26, wherein the cladded transparent metal includes a cladding comprising a gold, a titanium, a nickel chromium, an inconel, a copper, or any combination thereof.

Embodiment 28. The solar control film of any one of the preceding embodiments, wherein at least one of the first dark metal layer or the second dark metal layer, or both, includes a different metal or alloy than the transparent metal layer.

Embodiment 29. The solar control film of any one of embodiments 1-27, wherein the transparent metal layer includes the same metal or alloy as at least one of the first dark metal layer or the second dark metal layer.

Embodiment 30. The solar control film of any one of the preceding embodiments, wherein the multilayer stack includes a first interference layer, a second interference layer, or both, providing an interference effect providing a single absorption peak in the range of visible wavelengths of light.

Embodiment 31. The solar control film of any one of the preceding embodiments, the multilayer stack includes a first interference layer, a second interference layer, or both, providing an interference effect creates a single absorption peak in the range of visible wavelengths.

Embodiment 32. The solar control film of any one of the preceding embodiments, the multilayer stack includes a first interference layer, a second interference layer, or both, including a non-absorbing material.

Embodiment 33. The solar control film of any one of the preceding embodiments, the multilayer stack includes a first interference layer, a second interference layer, or both, including a dielectric material.

Embodiment 34. The solar control film of any one of the preceding embodiments, the multilayer stack includes a first interference layer, a second interference layer, or both, including a metal oxide, a nitride, an oxynitride, or any combination thereof.

Embodiment 35. The solar control film of any one of the preceding embodiments, the multilayer stack includes a first interference layer, a second interference layer, or both, including a metal oxide, a nitride, an oxynitride of Mg, Y, Ti, Zr, Nb, Ta, W, Zn, Al, In, Sn, Sb, Bi, Ge, Si, or any combination thereof.

Embodiment 36. The solar control film of any one of the preceding embodiments, the multilayer stack includes a first interference layer, a second interference layer, or both, including an indium oxide, a titanium oxide, a zinc oxide, a tin oxide, silicon oxide or any combination thereof.

Embodiment 37. The solar control film of any one of the preceding embodiments, the multilayer stack includes a first interference layer, a second interference layer, or both, including an aluminum nitride, a silicon nitride, or a combination thereof.

Embodiment 38. The solar control film of any one of the preceding embodiments, the multilayer stack includes a first interference layer, a second interference layer, or both, having a thickness so as to cause an interference effect between the first and second metal layers.

Embodiment 39. The solar control film of any one of the preceding embodiments, wherein the first interference layer, and if present the second interference layer, or both, has a geometrical thickness of no greater than 60 nm, no greater than 50 nm, or no greater than 40 nm.

Embodiment 40. The solar control film of any one of the preceding embodiments, wherein the first interference layer, and if present the second interference layer, or both, has a geometrical thickness of at least 10 nm, at least 15 nm, or at least 20 nm.

Embodiment 41. The solar control film of any one of the preceding embodiments, wherein the first interference layer, and if present the second interference layer, or both, has a geometrical thickness in a range of 10 to 60 nm, 15 to 50 nm, or 20 to 40 nm.

Embodiment 42. The solar control film of any one of the preceding embodiments, wherein the first interference layer, and if present the second interference layer, or both, has an optical thickness of no greater than 120 nm, no greater than 100 nm, or no greater than 80 nm.

Embodiment 43. The solar control film of any one of the preceding embodiments, wherein the first interference layer, and if present the second interference layer, or both, has an optical thickness of at least 20 nm, at least 30 nm, or at least 40 nm.

Embodiment 44. The solar control film of any one of the preceding embodiments, wherein the first interference layer, and if present the second interference layer, or both, has an optical thickness in a range of 20 to 120 nm, 30 to 100 nm, or 40 to 80 nm.

Embodiment 45. The solar control film of any one of the preceding embodiments, wherein the first interference layer, and if present the second interference layer, or both, has a quarter wave optical thickness (QWOT) of no greater than 1.1, no greater than 0.8, or no greater than 0.6.

Embodiment 46. The solar control film of any one of the preceding embodiments, wherein the first interference layer, and if present the second interference layer, or both, has a quarter wave optical thickness (QWOT) of at least 0.25, at least 0.3, or at least 0.4.

Embodiment 47. The solar control film of any one of the preceding embodiments, wherein the first interference layer, and if present the second interference layer, or both, has a quarter wave optical thickness (QWOT) in a range of 0.25 to 1.1, 0.3 to 0.6, or 0.4 to 0.6.

Embodiment 48. The solar control film of any one of the preceding embodiments, wherein the multilayer stack includes the first and second interference layers.

Embodiment 49. The solar control film of embodiment 48, wherein the first and second interference layers include the same material.

Embodiment 50. The solar control film of embodiment 48, wherein the first and second interference layers include different materials.

Embodiment 51. The solar control film of any one of embodiments 49-50, wherein the first and second interference layers have the same geometrical thickness, optical thickness, QWOT, or any combination thereof.

Embodiment 52. The solar control film of any one of embodiments 48-50, wherein the first and second interference layers have a different geometrical thickness, optical thickness, QWOT, or any combination thereof.

Embodiment 53. The solar control film of any one of any one of the preceding embodiments, wherein the total geometrical thickness of all the interference layers in a single multilayer stack is no greater than 250 nm, no greater than 230 nm, or no greater than 200 nm.

Embodiment 54. The solar control film of any one of the preceding embodiments, wherein the multilayer stack has a metal/interference/metal layer configuration.

Embodiment 55. The solar control film of any one of the preceding embodiments, wherein the multilayer stack has a dark metal/interference/transparent metal layer configuration.

Embodiment 56. The solar control film of any one of the preceding embodiments, wherein the multilayer stack has a metal/interference/metal/interference/metal layer configuration.

Embodiment 57. The solar control film of any one of the preceding embodiments, wherein the multilayer stack has a dark metal/interference/transparent metal/interference/dark metal layer configuration.

Embodiment 58. The solar control film of any one of the preceding embodiments, wherein any interference layer in the multilayer stack is disposed between two metal layers.

Embodiment 59. The solar control film of any one of the preceding embodiments, wherein none of the interference layers in the multilayer stack are in contact with a substrate layer.

Embodiment 60. The solar control film of any one of the preceding embodiments, wherein the multilayer stack includes one or more dark metal layers separated from a transparent metal layer by an interference layer having a geometrical thickness of no greater than 100 nm.

Embodiment 61. The solar control film of any one of the preceding embodiments, comprising a substrate layer and a counter substrate layer, wherein the multilayer stack is disposed between the substrate layer and the counter substrate layer.

Embodiment 62. The solar control film of any one of the preceding embodiments, wherein the substrate layer includes a glass or a polymer.

Embodiment 63. The solar control film of any one of embodiments 61 or 62, wherein the counter substrate layer includes a glass or a polymer.

Embodiment 64. The solar control film of any one of the preceding embodiments, comprising a substrate layer and a counter substrate layer, each including a polymer including a polycarbonate, a polyacrylate, a polyester, a cellulose triacetate (TCA or TAC), a polyurethane, a fluoropolymer, or any combination thereof.

Embodiment 65. The solar control film of one of embodiments 61-63, wherein the substrate layer and the counter substrate layer comprise the same material.

Embodiment 66. The solar control film of one of embodiments 61-64, wherein the substrate layer, the counter layer, or both, includes a transparent layer.

Embodiment 67. The solar control film of one of embodiments 61-65, wherein the substrate layer, the counter layer, or both, includes a clear substrate layer.

Embodiment 68. The solar control film of one of embodiments 61-66, wherein the substrate layer, the counter layer, or both, includes an uncolored substrate layer.

Embodiment 69. The solar control film of any one of embodiments 61-67, wherein the substrate layer and the counter layer are free of a dye.

Embodiment 70. The solar control film of any one of the preceding embodiments, wherein the solar control film has a VLT of no greater than 40%, a VLR of no greater than 12%, and wherein the VLT and the SHGC of the solar control film satisfy the following formula:

VLT-1.8(SHGC)≧SCF,
wherein the solar control film has an SCF (solar control factor) of at least −0.4, at least −0.38, or at least −0.36.

Embodiment 71. The solar control film of any one of the preceding embodiments, wherein the solar control film is a low VLT film.

Embodiment 72. The solar control film of any one of the preceding embodiments, wherein the solar control film has a VLT of no greater than 40%, no greater than 30%, no greater than 20%, no greater than 15%, no greater than 12%, or no greater than 10%.

Embodiment 73. The solar control film of any one of the preceding embodiments, wherein the solar control film has a VLT of at least 3%, at least 5%, or at least 7%.

Embodiment 74. The solar control film of any one of the preceding embodiments, wherein the solar control film has a VLT in a range of 3 to 50%, 5 to 40%, 7 to 30%, 3 to 15%, 3 to 12%, or even 3 to 10%.

Embodiment 75. The solar control film of any one of the preceding embodiments, wherein the solar control film has a SHGC of no greater than 50%, no greater than 40%, no greater than 35%, or no greater than 30%.

Embodiment 76. The solar control film of any one of the preceding embodiments, wherein the solar control film has a SHGC of at least 1%, at least 5%, or at least 10%.

Embodiment 77. The solar control film of any one of the preceding embodiments, wherein the solar control film has a SHGC in a range of 0 to 50%, 1 to 40%, 5 to 35%, or 10 to 30%.

Embodiment 78. The solar control film of any one of the preceding embodiments, wherein the solar control film has a VLR of no greater than 30%, no greater than 20%, no greater than 15%, no greater than 12%, no greater than 10%, or no greater than 8%.

Embodiment 79. The solar control film of any one of the preceding embodiments, wherein the solar control film has a VLR of at least 1%, at least 2%, or at least 3%.

Embodiment 80. The solar control film of any one of the preceding embodiments, wherein the solar control film has a VLR in a range of 0 to 30%, 1 to 20%, 2 to 15%, 3 to 12%, 3 to 10%, or even 3 to 8%.

Embodiment 81. The solar control film of any one of the preceding embodiments, wherein the solar control film has a VLR_{F} (film-side) of no greater than 14%, no greater than 12%, or no greater than 10%.

Embodiment 82. The solar control film of any one of the preceding embodiments, wherein the solar control film has a VLR_{F} (film-side) of at least 1%, at least 2% or at least 3%.

Embodiment 83. The solar control film of any one of the preceding embodiments, wherein the solar control film has a VLR_{F} (film-side) in a range of 1 to 14%, 2 to 12%, or 3 to 10%.

Embodiment 84. The solar control film of any one of the preceding embodiments, wherein the solar control film has a VLR_{G} (glass-side) of no greater than 14%, no greater than 12%, or no greater than 10%.

Embodiment 85. The solar control film of any one of the preceding embodiments, wherein the solar control film has a VLR_{G} (glass-side) of at least 1%, at least 2% or at least 3%.

Embodiment 86. The solar control film of any one of the preceding embodiments, wherein the solar control film has a VLR_{G} (glass-side) in a range of 1 to 14%, 2 to 12%, or 3 to 10%.

Embodiment 87. The solar control film of any one of the preceding embodiments, wherein the solar control film has a VLR_{G} (glass-side) that is greater than or less than a VLR_{F} (film-side).

Embodiment 88. The solar control film of any one of the preceding embodiments, wherein the solar control film has a VLR_{G} (glass-side) that is less than the VLR_{F} (film-side) by at least 5%, at least 10%, or at least 15% less.

Embodiment 89. The solar control film of any one of the preceding embodiments, wherein the solar control film has a substantially neutral color.

Embodiment 90. The solar control film of any one of the preceding embodiments, wherein only the multilayer stack contributes to the solar control functionality.

Embodiment 91. The solar control film of any one of the preceding embodiments, wherein only the multilayer stack contributes to a reduction in VLT.

Embodiment 92. The solar control film of any one of the preceding embodiments, wherein only the multilayer stack contributes to a reduction in VLR.

Embodiment 93. A solar control laminate including the solar control film of any one of the preceding embodiments laminated between glass layers.

Embodiment 94. The solar control laminate of embodiment 93, wherein a mechanical energy-absorbing layer is disposed between each of the glass layers and the solar control film.

Embodiment 95. The solar control laminate of embodiment 94, wherein the counter substrate layer includes one of the mechanical energy-absorbing layers.

Embodiment 96. The solar control laminate of embodiment 94 or 95, wherein the mechanical energy-absorbing layer includes a plasticized polyvinyl butyral (PVB).

### EXAMPLES

The concepts described herein will be further described in the following Examples, which do not limit the scope of the invention described in the claims. Some of the parameters below have been approximated for convenience.

In the Examples below, the sample films are prepared by providing a standard substrate layer (PET, 50 microns). A multilayer stack is deposited on one side of the standard substrate layer using a magnetron sputter coater. In particular, after pumping down to a base pressure below 5e-5 mbar, the metal layers are deposited using the appropriate metal targets and Ar as the gas in the chamber. The pressure is maintained at 2.5e-3 mbar. The titanium oxide (TiO) layer is deposited using a TiO ceramic substoichiometric target and a mixture of Ar and O₂ in the chamber. The substrate/multilayer system is then laminated to a counter substrate layer (PET, 1 mil) using a basic laminating adhesive. A pressure sensitive adhesive is applied on the opposite side of the counter substrate layer. The substrate/multilayer/substrate system is then laminated on a glass substrate layer (clear glass, 3 mm) by first wetting the surface of the glass, applying the pressure adhesive surface against the wet glass, and squeegeeing the excess of water while taking extra care to remove any bubbles.

The optical properties are measured using a Perkin-Elmer spectrophotometer between 300 nm and 2500 nm with steps of 5 nm. Transmittance and reflectance are measured for both sides (glass and film) of the sample. The integrated values, such as VLT, VLR, and TSER, are derived from the measurement using the standards described earlier in the application.

### Example 1

### Cu as the Transparent Metal Layer

Two samples of solar control films according to certain embodiments of the solar control film described herein are made according to the method described above using Cu as the transparent metal layer. Sample 1 has a Glass/PET/Ti/TiO/Cu/TiO/Ti/PET configuration. Sample 2 has a similar configuration except that TiO is replaced with ITO. The materials and thicknesses for each layer is provided below in Table 2.

TABLE 2

| | | Sample 1 | | Sample 2 | |
|---|---|---|---|---|---|
| Layer | Units | Material | Thickness | Material | Thickness |
| Glass | Mm | — | 3 | — | 3 |
| Substrate | Micron | PET | 25 | PET | 25 |
| Dark Metal | Nm | Ti | 8 | Ti | 8.8 |
| Interference | Nm | TiO | 42.2 | TiO | 39.8 |
| Transparent Metal | Nm | Cu | 21.8 | Cu | 13 |
| Interference | Nm | TiO | 42.2 | TiO | 39.8 |
| Dark Metal | Nm | Ti | 8 | Ti | 8.8 |
| Substrate | Micron | PET | 50 | PET | 50 |

The solar control and color properties of Sample 1 and Sample 2 are measured and the results are provided below in Table 3.

TABLE 3

| Property | Sample 1 | Sample 2 |
|---|---|---|
| VLT | 15.5% | 15.1% |
| VLR (g) | 5.5% | 7.3% |
| VLR (f) | 6.9% | 8.7% |
| SHGC | 27% | 28% |
| TSER | 73% | 72% |
| Selectivity | 0.57 | 0.54 |
| SCF | −0.33 | −0.35 |

The results in Table 3 indicate that Samples 1 and 2 provide a superior combination of low VLT, low VLR, low SHGC (high TSER), and high selectivity.

### Example 2

### Ag as the Transparent Metal Layer

Six samples of solar control films according to certain embodiments of the solar control film described herein are made according to the method described above using Ag as the transparent metal layer. Each of Samples 3-8 has a Glass/PET/Ti/TiO/Ag/TiO/Ti/PET configuration. The layer thicknesses are modified for each sample, as provided below in Table 4.

TABLE 4

| | | Sa. 3 | Sa. 4 | Sa. 5 | Sa. 6 | Sa. 7 | Sa. 8 |
|---|---|---|---|---|---|---|---|
| Layer | Units | Thick. | Thick. | Thick. | Thick. | Thick. | Thick. |
| Glass | mm | 3 | 3 | 3 | 3 | 3 | 3 |
| Substrate (PET) | micron | 25 | 25 | 25 | 25 | 25 | 25 |
| Dark Metal (Ti) | nm | 8.6 | 7.7 | 6.8 | 5.9 | 5.2 | 4.5 |
| Interference | nm | 31.9 | 30.5 | 29.4 | 28.5 | 27.7 | 27 |
| (TiO) | | | | | | | |
| Transparent | nm | 17.7 | 15.3 | 13.6 | 12.4 | 11.6 | 10.9 |
| Metal (Ag) | | | | | | | |
| Interference | nm | 31.9 | 30.5 | 29.4 | 28.5 | 27.7 | 27 |
| (TiO) | | | | | | | |
| Dark Metal (Ti) | nm | 8.6 | 7.7 | 6.8 | 5.9 | 5.2 | 4.5 |
| Substrate (PET) | micron | 25 | 25 | 25 | 25 | 25 | 25 |

The solar control properties of Samples 3-8 are measured according to the methods previously described in the application. The results provided below in Table 5 demonstrate a range of performances that can be obtained according to embodiments of this disclosure by adapting different thicknesses.

TABLE 5

| | | | Sam- | Sam- | Sam- | Sam- |
|---|---|---|---|---|---|---|
| Property | Sample 3 | Sample 4 | ple 5 | ple 6 | ple 7 | ple 8 |
| VLT | 15.0% | 19.9% | 24.9% | 29.9% | 35.1% | 39.9% |
| VLR (g) | 8.0% | 8.0% | 8.1% | 8.1% | 8.1% | 8.1% |
| VLR (f) | 8.0% | 8.0% | 8.0% | 8.0% | 7.8% | 7.9% |
| SHGC | 27.6% | 30.3% | 33.1% | 36.0% | 38.9% | 41.7% |
| TSER | 72.4% | 69.7% | 66.9% | 64.0% | 61.1% | 58.3% |
| SCF | −0.35 | −0.35 | −0.35 | −0.35 | −0.35 | −0.35 |

### Example 3

### Transparent Metal/Interference/Dark Metal Design

Three samples of solar control films according to certain embodiments of the solar control film described herein are made according to the method described above using Ag as the transparent metal layer, a single dark metal layer, and a single interference layer. Each of Samples 9-11 has a Glass/PET/Ti/TiO/Ag configuration. The layer thicknesses are modified for each sample, as provided below in Table 6.

TABLE 6

| | | Sample 9 | Sample 10 | Sample 11 |
|---|---|---|---|---|
| Layer | Units | Thickness | Thickness | Thickness |
| Glass | mm | 3 | 3 | 3 |
| Substrate (PET) | micron | 25 | 25 | 25 |
| Dark Metal (Ti) | Nm | 15.3 | 14.6 | 20 |
| Interference (TiO) | Nm | 56.8 | 52.9 | 56.3 |
| Transparent Metal (Ag) | Nm | 6 | 6 | 6.3 |
| Substrate (PET) | micron | 25 | 26 | 27 |

The solar control properties of Samples 9-11 are measured according to the methods previously described in the application. The results provided below in Table 7 demonstrate a range of performances that can be obtained with a simplified multilayer limited to a transparent metal layer (including potentially its cladding layers), an interference layer, and a dark metal layer. For example, for the VLT range between 30% and 40%, the dark metal/interference/transparent metal configuration exhibits the distinctive advantage of higher performance and simpler design, which translates into reduced manufacturing cost.

TABLE 7

| Property | Sample 9 | Sample 10 | Sample 11 |
|---|---|---|---|
| VLT | 38.7% | 39.3% | 31.5% |
| VLR (g) | 7.9% | 9.0% | 8.6% |
| VLR (f) | 10.3% | 11.1% | 8.4% |
| SHGC | 39.2% | 39.8% | 34.2% |
| TSER | 60.8% | 60.2% | 65.8% |
| SCF | −0.32 | −0.32 | −0.30 |

### Example 4

### Comparative Samples

Example 4 includes a glass substrate and five additional samples of optical filters (Samples 12-16). The glass substrate (3 mm clear Planilux® brand glass substrate from Saint-Gobain Performance Plastics available at San Diego, Calif., USA) is free of a multilayer stack. Samples 12-16 are various existing solar control films from Saint-Gobain Performance Plastics available at San Diego, Calif., USA. See Table 8 below.

TABLE 8

| Property | Sample 12 | Sample 13 | Sample 14 | Sample 15 |
|---|---|---|---|---|
| VLT | 6% | 12% | 21% | 23% |
| VLR (g) | 10% | 6% | 8% | 5% |
| VLR (f) | 10% | 6% | 6% | 6% |
| SHGC | 30% | 33% | 41% | 35% |
| TSER | 70% | 67% | 59% | 65% |
| SCF | −0.48 | −0.47 | −0.53 | −0.40 |

Sample 12 includes a ⅛ inch clear glass layer having a pressure sensitive adhesive (PSA) bonding the glass layer to a window film. The window film is a 3-ply window film including a first ply including dyed PET film (35% VLT) in contact with the PSA and having a first basic adhesive (BA) opposite the PSA; a second ply including clear PET film coated with a vacuum-deposited Al layer (35% VLT) in contact on one side with the BA of the first dyed film and having a second BA opposite the first dyed film; and a third ply including a dyed PET film same as the first ply, having one side in contact with the second BA, and the opposite side having an acrylate-based hardcoat.

Sample 13 is similar to Sample 12 except that the window film is a 2-ply window film including a first ply including dye 15% VLT film and a second ply including a clear PET film covered on one side with vacuum deposited multilayer stack. The multilayer stack includes a first dielectric layer, a first cladded layer of Ag, a second dielectric layer, a second cladded layer of Ag, and a third dielectric layer.

Sample 14 is similar to Sample 12 except that the window film is a 3-ply window film including a first clear PET film having a vacuum-deposited layer of chromium having a VLT of 40% in contact with a basic adhesive. The second ply includes a clear PET film coated with a vacuum deposited Al layer having a VLT of 55%. The third ply is the same as the first play. The construction of Sample 14 differs from embodiments of the solar control film of this disclosure in that the dark metal-clear metal-dark metal structure is separated by thick clear PET layers that do not provide the interferometric effect of embodiments of the solar control of this disclosure.

Sample 15 is similar to Sample 12 except that the window film is a 2-ply film including a first ply including a dyed PET film having a VLT of 25% and a second ply including a clear PET film coated with a vacuum deposited multilayer stack. The multilayer stack included a first dielectric layer, a first cladded layer of Ag, a second dielectric layer, a second cladded layer of Ag, and a third dielectric layer.

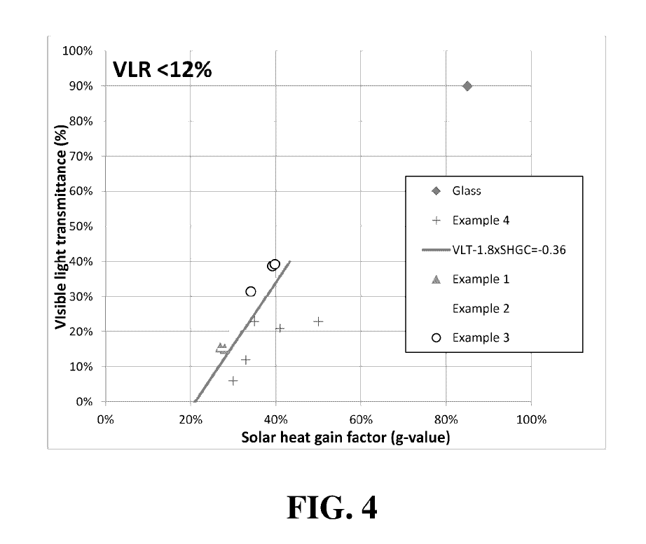

As illustrated in FIG. 4, the samples of Examples 1-3 fall on the left side of the linear regression representing a particular SCF formula, whereas the samples of Example 4 fall on the right side of the linear regression and, thus, do not satisfy the given SCF formula. The glass substrate also falls to the right of the linear regression and does not fall below 40% VLT. This result illustrates the superior performance of the configuration of the multilayer stack according to certain embodiments described herein, particularly where a transparent metal layer and a dark metal layer separated by an interference layer.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A solar control film comprising:
a substrate layer;
a multilayer stack disposed between the substrate layer and the counter layer,
wherein the solar control film has a visible light reflectance (VLR) of no greater than 12%, visible light transmittance (VLT) of no greater than 40%, and a solar control factor (SCF) of −0.38, and
wherein the VLT and a solar heat gain coefficient (SHGC) of the solar control film satisfy the following formula:
VLT-1.8(SHGC)≧SCF.

2. The solar control film of claim 1, wherein the multilayer stack includes:
a dark metal layer;
a transparent metal layer; and
a first interference layer disposed between the first dark metal layer and the transparent metal layer.

3. The solar control film of claim 2, wherein either:
a) the first dark metal layer and the transparent metal layer are the outermost layers of the of the multilayer stack, or b) the multilayer stack further comprises a second dark metal layer and a second interference layer disposed between the transparent metal layer and the second dark metal layer.

4. The solar control film of claim 3, wherein the first dark metal layer, the second dark metal layer, or both, have a k/n ratio of at least 0.5.

5. The solar control film of claim 3, wherein the first dark metal layer, the second dark metal layer, or both, have a k/n ratio of no greater than 2.

6. The solar control film of claim 3, wherein the first dark metal layer, the second dark metal layer, or both, include a metal or alloy including a titanium, a nickel, a chromium, an iridium, an iron, an inconel, a stainless steel, an NiCr, or any combination.

7. The solar control film of claim 3, wherein the first dark metal layer, the second dark metal layer, or both, have a geometrical thickness of at least 2 nm.

8. The solar control film of claim 3, wherein the first dark metal layer, the second dark metal layer, or both, have a geometrical thickness of no greater than 24 nm.

9. The solar control film of claim 3, wherein the first dark metal layer, the second dark metal layer, or both, comprise a continuous layer.

10. The solar control film of claim 3, wherein the first dark metal layer, the second dark metal layer, or both, comprise a discontinuous layer.

11. The solar control film of claim 3, wherein the first dark metal layer and the second dark metal layer are identical to each other.

12. The solar control film of claim 3, wherein the transparent metal layer has a k/n ratio of at least 1.85.

13. The solar control film of claim 3, wherein the transparent metal layer includes a transparent metal comprising a gold, a copper, a silver, or any combination thereof.

14. The solar control film of claim 13, wherein the transparent metal layer includes a silver alloy including a gold, a palladium, a copper, or any combination thereof.

15. A solar control film comprising:
a multilayer stack including:
a first dark metal layer;
a second dark metal layer;
a transparent metal layer;
a first interference layer disposed between the first dark metal layer and the transparent metal layer; and
a second interference layer disposed between the transparent metal layer and the second dark metal layer.

16. The solar control film of claim 15, wherein the first dark metal layer, the second dark metal layer, or both, have a k/n ratio of at least 0.5.

17. The solar control film of claim 15, wherein the first dark metal layer, the second dark metal layer, or both, have a k/n ratio of no greater than 2.

18. The solar control film of claim 15, wherein the first dark metal layer, the second dark metal layer, or both, comprise a continuous layer.

19. The solar control film of claim 15, wherein the first dark metal layer, the second dark metal layer, or both, comprise a discontinuous layer.

20. The solar control film of claim 15, wherein the transparent metal layer includes a transparent metal comprising a gold, a copper, a silver, or any combination thereof.
